(19) United States
(12) Patent Application Publication
(10) Pub. No.: US 2025/0063455 A1
(43) Pub. Date: Feb. 20, 2025

(54) UE POSITIONING/LOCATION ASSISTED CONDITIONAL HANDOVER

(71) Applicant: Nokia Technologies Oy, Espoo (FI)

(72) Inventors: Amaanat ALI, Espoo (FI); Sina KHATIBI, Munich (DE); Ahmad AWADA, Munich (DE); Mikko SÄILY, Laukkoski (FI); Anna PANTELIDOU, Massy (FR)

(21) Appl. No.: 18/721,270

(22) PCT Filed: Dec. 21, 2021
(86) PCT No.: PCT/EP2021/086968

§ 371 Date: Jun. 18, 2024

(51) Int. Cl. H04W 36/36; H04W 36/00; H04W 36/32

(52) U.S. Cl. CPC H04W 36/362; H04W 36/00838; H04W 36/322

(57) ABSTRACT

A method including monitoring whether a source cell has configured a terminal and a target cell for a conditional handover of the terminal from the source cell to the target cell; estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell; and at least one of informing the target cell on the handover delay period; and checking whether the handover delay period is larger than a predefined threshold; and cancelling the conditional handover configuration of the terminal and the target cell if the handover delay period is longer than the predefined threshold.

### FIELD OF THE INVENTION

The present disclosure relates to conditional handover.

### BACKGROUND

3GPP TR 37.817, section 5.3 lists objectives of Mobility Optimization using Artificial Intelligence (AI)/Machine Learning (ML). One of the objectives is as follows:
Objective 2: Leverage UE location prediction in enhancing mobility related procedure.

In this track, solutions that leverage the location/position of the UE in enhancing the mobility procedure will be discussed:
Enhanced selection of the target cell in the following scenarios
   Primary cell (PCell) for New Radio (NR) standalone handover [both baseline (Rel-15) and conditional handover (CHO)]
   Primary SCG (Second Cell Group) cell (PSCeII) for addition/change for dual connectivity scenarios (both baseline (Rel-15) and Conditional PSCeII Addition/Change (CPAC)
Data forwarding for all the above mentioned scenarios
Improving mobility related decisions (e.g. altering prepared cells, resource utilization, . . . )

The CHO is similar to a legacy (unconditional) handover. The CHO Request and CHO Request Acknowledgment may be the same as a HO Request and a HO Request Acknowledgment. The first steps are identical to the legacy handover. A configured event triggers the UE to send a measurement report. Based on this report, the source cell typically prepares the target cell (or multiple candidate target cells) for the handover (Handover Request+Handover Request Acknowledgement). The handover request comprises information on the configuration of the terminal, and the target cell derives and stores a set of configuration data of the terminal from the information contained in the handover request. Furthermore, based on the set of configuration data, the target cell prepares a CHO configuration which is contained in the handover request acknowledgment to the source cell. Then, the source cell sends a (conditional) handover command to the UE which comprises the CHO configuration. It is up to the network when to use CHO: E.g., the source cell may configure the UE (and the target cell) with CHO command even without any measurement reports, e.g. in cases where the deployments are uniform.

For the legacy (unconditional) HO, the UE immediately accesses the target cell to complete the handover. Instead, for CHO, the UE will only access the target cell once an additional CHO execution condition expires. The condition is typically configured, e.g. by the source cell during HO Command.

The advantage of the CHO compared to conventional (unconditional) HO is that the HO command can be sent very early, when the UE is still safe in the source cell, without risking the access into and the stability of the target cell.

In CHO, the source gNB can set an IE in Handover Request, called “UE incoming probability”, to inform the target gNB about the likelihood that the UE ends up accessing the target cell for which the handover request is sent for. In case the source gNB detects later on, after the target cell has been prepared, that the UE is stationary (based on the estimated UE location), the source gNB can send a request to update the CHO configuration and set UE incoming probability IE to small value (if the previous value of the IE was high due to high UE speed). A smaller incoming probability value allows the target gNB to enable overbooking of radio resources that are reserved for the UE as the probability that it shows up in the target cell is currently low (as the UE is stationary). Overbooking means that radio resources which are reserved for the UE when and after it performs the CHO are used by other UEs.

In the present application, the terms “base station” (or gNB) and “cell” are used synonymously, unless otherwise indicated or made clear from the context. The base station represents the respective cell. The base station may be integrated, or it may be split into a central unit (CU) and one or more distributed units (DU), and potentially a number of remote units (RU).

### SUMMARY

It is an object of the present invention to improve the prior art.

According to a first aspect of the invention, there is provided an apparatus comprising:
one or more processors, and memory storing instructions that, when executed by the one or more processors, cause the apparatus to perform:
   monitoring whether a source cell has configured a terminal and a target cell for a conditional handover of the terminal from the source cell to the target cell;
estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell; and at least one of
   informing the target cell on the handover delay period; and
   checking whether the handover delay period is larger than a predefined threshold; and cancelling the conditional handover configuration of the terminal and the target cell if the handover delay period is longer than the predefined threshold.

The instructions, when executed by the one or more processors, may further cause the apparatus to perform:
checking whether, according to the prediction, the terminal is stationary;
setting the handover delay period to a predefined large value.

The instructions, when executed by the one or more processors, may further cause the apparatus to perform at least one of:
obtaining the prediction of the likely future movement of the terminal.

The instructions, when executed by the one or more processors, may further cause the apparatus to perform at least one of:
the obtaining the prediction by generating the prediction based on at least one of an estimation of a location of the terminal together with an estimation of a speed of the terminal and a movement direction of the terminal and estimations of locations of the terminal at different points in time; and
the obtaining the prediction by receiving the prediction.

The instructions, when executed by the one or more processors, may further cause the apparatus to perform, if the prediction is obtained by generating the prediction:
requesting the at least one of the estimation of the location of the terminal together with the estimation of the speed of the terminal and the movement direction of the terminal and the estimations of the locations of the terminal at different points in time if the source cell configures the terminal and the target cell for the conditional handover.

According to a second aspect of the invention, there is provided an apparatus comprising:
one or more processors, and memory storing instructions that, when executed by the one or more processors, cause the apparatus to perform:
supervising whether a target cell is configured, by a source cell, for a conditional handover of a first terminal from the source cell to the target cell, wherein the configuring of the target cell for the conditional handover of the first terminal comprises reserving a resource of the target cell for the first terminal;
monitoring whether an information on a handover delay period for the conditional handover is received from the source cell, wherein the handover delay period indicates a time period for which the first terminal will likely not perform the conditional handover to the target cell;
controlling the resource of the target cell in accordance with the handover delay period if the target cell is configured for the conditional handover of the first terminal and the information on the handover delay period is received.

The instructions, when executed by the one or more processors, may further cause the apparatus to perform:
checking whether the handover delay period is longer than a first predetermined threshold; wherein
the controlling comprises admitting to use the resource for a second terminal different from the first terminal during the handover delay period or a predefined portion of the handover delay period if the handover delay period is longer than the predetermined threshold.

The controlling may comprise reserving the resource for the first terminal after the handover delay period and the predefined portion of the handover delay period, respectively, has elapsed.

The instructions, when executed by the one or more processors, may further cause the apparatus to perform:
checking whether the handover delay period is longer than a second predetermined threshold;
informing the source cell that the target cell is not prepared for the conditional handover of the first terminal if the handover delay period is longer than the second predetermined threshold; wherein
the controlling may comprise deleting the reservation of the resource for the first terminal if the handover delay period is longer than the second predetermined threshold.

The monitoring whether the information on the handover delay period for the conditional handover is received from the source cell may comprise monitoring whether a cancellation of the configuration for the conditional handover of the terminal is received along with the information on the handover delay period, and the instructions, when executed by the one or more processors, may further cause the apparatus to perform:
maintaining a context of the terminal for a period of time longer than the handover delay period.

According to a third aspect of the invention, there is provided an apparatus comprising:
one or more processors, and memory storing instructions that, when executed by the one or more processors, cause the apparatus to perform:
monitoring whether a terminal is configured for conditional handover from a source cell to a target cell;
requesting at least one of an estimation of a location of the terminal together with an estimation of a speed and a movement direction of the terminal and estimations of locations of the terminal at different points in time if the terminal is configured for the conditional handover; and at least one of
   providing the at least one of the estimation of the location of the terminal together with the estimation of the speed of the terminal and the movement direction of the terminal and the estimations of the locations of the terminal at different points in time received in response to the requesting to the source cell; and
   generating a prediction of a likely future movement of the terminal based on the at least one of the estimation of the location of the terminal together with the estimation of the speed of the terminal and the movement direction of the terminal and the estimations of the locations of the terminal at different points in time received in response to the requesting, and providing the prediction to the source cell.

According to a fourth aspect of the invention, there is provided an apparatus comprising:
one or more processors, and memory storing instructions that, when executed by the one or more processors, cause the apparatus to perform:
estimating an assumed handover delay period, wherein the assumed handover delay period indicates a time period for which, according to a prediction of a likely future movement of a terminal, the terminal will likely not perform a conditional handover from a source cell to a target cell under the assumption that the source cell configures the terminal and the target cell for the conditional handover;
   monitoring whether the source cell receives a first delay threshold from the target cell; checking whether the assumed handover delay period is larger than the first delay threshold if the source cell receives the first delay threshold;
   inhibiting the configuring the terminal and the target cell for the conditional handover if the assumed handover delay period is larger than the first delay threshold.

The instructions, when executed by the one or more processors, may further cause the apparatus to perform:
checking whether the terminal and the target cell have been configured for the conditional handover from the source cell to the target cell;
estimating an estimated handover delay period, wherein the estimated handover delay period indicates a time period for which, according to the prediction, the terminal will likely not perform the conditional handover;
monitoring whether the source cell receives a second delay threshold from the target cell;
checking whether the estimated handover delay period is longer than the second delay period if the second delay threshold is received;
cancelling the configurations of the terminal and the target cell for the conditional handover if the estimated handover delay period is longer than the second delay threshold.

The instructions, when executed by the one or more processors, may further cause the apparatus to perform:
obtaining the prediction of the likely future movement of the terminal.

According to a fifth aspect of the invention, there is provided an apparatus comprising:
one or more processors, and memory storing instructions that, when executed by the one or more processors, cause the apparatus to perform:
obtaining a prediction of a likely future movement of a terminal;
determining whether the terminal and a target cell have been configured for a conditional handover of the terminal from a source cell to the target cell;
estimating a handover delay period if the terminal and the target cell have been configured for the conditional handover, wherein the handover delay period indicates a time period for which, according to the prediction, the terminal will likely not perform the conditional handover from the source cell to the target cell;
monitoring whether the source cell receives a delay threshold from the target cell; checking whether the handover delay period is larger than the delay threshold if the source cell receives the delay threshold;
cancelling the configuration of the terminal and the target cell for the conditional handover if the handover delay period is larger than the delay threshold.

According to a sixth aspect of the invention, there is provided an apparatus comprising:
one or more processors, and memory storing instructions that, when executed by the one or more processors, cause the apparatus to perform:
determining a handover delay threshold based on an estimated load of resources of a target cell, wherein the handover delay threshold indicates a maximum acceptable time for a delay between a time when the target cell is configured for a conditional handover of a terminal from a source cell to the target cell and a time when the terminal executes the conditional handover;
informing the source cell on the handover delay threshold.

The instructions, when executed by the one or more processors, may further cause the apparatus to perform:
estimating the load of the resources of the target cell.

According to a seventh aspect of the invention, there is provided an apparatus comprising:
one or more processors, and memory storing instructions that, when executed by the one or more processors, cause the apparatus to perform:
   monitoring whether a source cell configures a terminal and a target cell for a conditional handover of the terminal from the source cell to the target cell;
estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell;
supervising whether the source cell obtains an indication of an actual delay of the conditional handover;
adapting the prediction based on the actual delay and the handover delay period if the source cell obtains the indication of the actual delay.

The supervising may comprise supervising whether the source cell receives an indication of an actual delay of the conditional handover from the target cell.

The instructions, when executed by the one or more processors, may further cause the apparatus to perform:
determining an actual delay of the conditional handover based on a signaling message received for an execution of the conditional handover.

The instructions, when executed by the one or more processors, may further cause the apparatus to perform:
obtaining the prediction of the likely future movement of the terminal.

According to an eighth aspect of the invention, there is provided an apparatus comprising:
one or more processors, and memory storing instructions that, when executed by the one or more processors, cause the apparatus to perform:
monitoring whether a terminal performs a conditional handover from a source cell to a target cell after the source cell configured the target cell for the conditional handover;
providing, to the source cell, if the terminal performs the conditional handover, an indication of a delay between a first time when the source cell configured the target cell for the conditional handover and a second time when the terminal performs the conditional handover.

According to a ninth aspect of the invention, there is provided a method comprising:
monitoring whether a source cell has configured a terminal and a target cell for a conditional handover of the terminal from the source cell to the target cell;
estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell; and at least one of
   informing the target cell on the handover delay period; and
   checking whether the handover delay period is larger than a predefined threshold; and cancelling the conditional handover configuration of the terminal and the target cell if the handover delay period is longer than the predefined threshold.

The method may further comprise:
checking whether, according to the prediction, the terminal is stationary;
setting the handover delay period to a predefined large value.

The method may further comprise:
obtaining the prediction of the likely future movement of the terminal.

The method may further comprise:
the obtaining the prediction by generating the prediction based on at least one of an estimation of a location of the terminal together with an estimation of a speed of the terminal and a movement direction of the terminal and estimations of locations of the terminal at different points in time; and
the obtaining the prediction by receiving the prediction.

The method may further comprise, if the prediction is obtained by generating the prediction:
requesting the at least one of the estimation of the location of the terminal together with the estimation of the speed of the terminal and the movement direction of the terminal and the estimations of the locations of the terminal at different points in time if the source cell configures the terminal and the target cell for the conditional handover.

According to a tenth aspect of the invention, there is provided a method comprising:
supervising whether a target cell is configured, by a source cell, for a conditional handover of a first terminal from the source cell to the target cell, wherein the configuring of the target cell for the conditional handover of the first terminal comprises reserving a resource of the target cell for the first terminal;
monitoring whether an information on a handover delay period for the conditional handover is received from the source cell, wherein the handover delay period indicates a time period for which the first terminal will likely not perform the conditional handover to the target cell;
controlling the resource of the target cell in accordance with the handover delay period if the target cell is configured for the conditional handover of the first terminal and the information on the handover delay period is received.

The method may further comprise:
checking whether the handover delay period is longer than a first predetermined threshold; wherein
the controlling comprises admitting to use the resource for a second terminal different from the first terminal during the handover delay period or a predefined portion of the handover delay period if the handover delay period is longer than the predetermined threshold.

The controlling may comprise reserving the resource for the first terminal after the handover delay period and the predefined portion of the handover delay period, respectively, has elapsed.

The method may further comprise:
checking whether the handover delay period is longer than a second predetermined threshold;
informing the source cell that the target cell is not prepared for the conditional handover of the first terminal if the handover delay period is longer than the second predetermined threshold; wherein
the controlling may comprise deleting the reservation of the resource for the first terminal if the handover delay period is longer than the second predetermined threshold. The monitoring whether the information on the handover delay period for the conditional handover is received from the source cell may comprise monitoring whether a cancellation of the configuration for the conditional handover of the terminal is received along with the information on the handover delay period, and the method may further comprise:
maintaining a context of the terminal for a period of time longer than the handover delay period.

According to an eleventh aspect of the invention, there is provided a method comprising:
monitoring whether a terminal is configured for conditional handover from a source cell to a target cell;
requesting at least one of an estimation of a location of the terminal together with an estimation of a speed and a movement direction of the terminal and estimations of locations of the terminal at different points in time if the terminal is configured for the conditional handover; and at least one of
   providing the at least one of the estimation of the location of the terminal together with the estimation of the speed of the terminal and the movement direction of the terminal and the estimations of the locations of the terminal at different points in time received in response to the requesting to the source cell; and
   generating a prediction of a likely future movement of the terminal based on the at least one of the estimation of the location of the terminal together with the estimation of the speed of the terminal and the movement direction of the terminal and the estimations of the locations of the terminal at different points in time received in response to the requesting, and providing the prediction to the source cell.

According to a twelfth aspect of the invention, there is provided a method comprising:
estimating an assumed handover delay period, wherein the assumed handover delay period indicates a time period for which, according to a prediction of a likely future movement of a terminal, the terminal will likely not perform a conditional handover from a source cell to a target cell under the assumption that the source cell configures the terminal and the target cell for the conditional handover;
monitoring whether the source cell receives a first delay threshold from the target cell;
checking whether the assumed handover delay period is larger than the first delay threshold if the source cell receives the first delay threshold;
inhibiting the configuring the terminal and the target cell for the conditional handover if the assumed handover delay period is larger than the first delay threshold.

The method may further comprise:
checking whether the terminal and the target cell have been configured for the conditional handover from the source cell to the target cell;
estimating an estimated handover delay period, wherein the estimated handover delay period indicates a time period for which, according to the prediction, the terminal will likely not perform the conditional handover;
monitoring whether the source cell receives a second delay threshold from the target cell;
checking whether the estimated handover delay period is longer than the second delay period if the second delay threshold is received;
cancelling the configurations of the terminal and the target cell for the conditional handover if the estimated handover delay period is longer than the second delay threshold.

The method may further comprise:
obtaining the prediction of the likely future movement of the terminal.

According to a thirteenth aspect of the invention, there is provided a method comprising:
obtaining a prediction of a likely future movement of a terminal;
determining whether the terminal and a target cell have been configured for a conditional handover of the terminal from a source cell to the target cell;
   estimating a handover delay period if the terminal and the target cell have been configured for the conditional handover, wherein the handover delay period indicates a time period for which, according to the prediction, the terminal will likely not perform the conditional handover from the source cell to the target cell;
monitoring whether the source cell receives a delay threshold from the target cell; checking whether the handover delay period is larger than the delay threshold if the source cell receives the delay threshold;
cancelling the configuration of the terminal and the target cell for the conditional handover if the handover delay period is larger than the delay threshold.

According to a fourteenth aspect of the invention, there is provided a method comprising:
determining a handover delay threshold based on an estimated load of resources of a target cell, wherein the handover delay threshold indicates a maximum acceptable time for a delay between a time when the target cell is configured for a conditional handover of a terminal from a source cell to the target cell and a time when the terminal executes the conditional handover;
informing the source cell on the handover delay threshold.

The method may further comprise:
estimating the load of the resources of the target cell.

According to a fifteenth aspect of the invention, there is provided a method comprising:
monitoring whether a source cell configures a terminal and a target cell for a conditional handover of the terminal from the source cell to the target cell;
estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell;
supervising whether the source cell obtains an indication of an actual delay of the conditional handover;
adapting the prediction based on the actual delay and the handover delay period if the source cell obtains the indication of the actual delay.

The supervising may comprise supervising whether the source cell receives an indication of an actual delay of the conditional handover from the target cell.

The method may further comprise:
determining an actual delay of the conditional handover based on a signaling message received for an execution of the conditional handover.

The method may further comprise:
obtaining the prediction of the likely future movement of the terminal.

According to a sixteenth aspect of the invention, there is provided a method comprising:
monitoring whether a terminal performs a conditional handover from a source cell to a target cell after the source cell configured the target cell for the conditional handover;
providing, to the source cell, if the terminal performs the conditional handover, an indication of a delay between a first time when the source cell configured the target cell for the conditional handover and a second time when the terminal performs the conditional handover.

Each of the methods of the ninth to sixteenth aspects may be a method of assisted conditional handover.

According to a seventeenth aspect of the invention, there is provided a computer program product comprising a set of instructions which, when executed on an apparatus, is configured to cause the apparatus to carry out the method according to any of the ninth to sixteenth aspects. The computer program product may be embodied as a computer-readable medium or directly loadable into a computer.

According to some embodiments of the invention, at least one of the following advantages may be achieved:
Resources of target cell may be used more efficiently;
Signaling may be reduced;
Conditional handovers may not unduly load the target cell;
Predictions may be improved.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a flowchart of method 1 according to some example embodiments of the invention;

FIG. 2 shows a flowchart of method 2 according to some example embodiments of the invention;

FIG. 3 shows some example message sequences to trigger a location service request used according to some example embodiments of the invention;

FIG. 4 shows a flowchart of method 3 according to some example embodiments of the invention;

FIG. 5 shows a flowchart of method 4 according to some example embodiments of the invention;

FIG. 6 shows an apparatus according to an example embodiment of the invention;

FIG. 7 shows a method according to an example embodiment of the invention;

FIG. 8 shows an apparatus according to an example embodiment of the invention;

FIG. 9 shows a method according to an example embodiment of the invention;

FIG. 10 shows an apparatus according to an example embodiment of the invention;

FIG. 11 shows a method according to an example embodiment of the invention;

FIG. 12 shows an apparatus according to an example embodiment of the invention;

FIG. 13 shows a method according to an example embodiment of the invention;

FIG. 14 shows an apparatus according to an example embodiment of the invention;

FIG. 15 shows a method according to an example embodiment of the invention;

FIG. 16 shows an apparatus according to an example embodiment of the invention;

FIG. 17 shows a method according to an example embodiment of the invention;

FIG. 18 shows an apparatus according to an example embodiment of the invention;

FIG. 19 shows a method according to an example embodiment of the invention;

FIG. 20 shows an apparatus according to an example embodiment of the invention;

FIG. 21 shows a method according to an example embodiment of the invention;

FIG. 22 shows an apparatus according to an example embodiment of the invention;

FIG. 23 shows a method according to an example embodiment of the invention;

FIG. 24 shows an apparatus according to an example embodiment of the invention;

FIG. 25 shows a method according to an example embodiment of the invention; and

FIG. 26 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

For CHO, there is neither a concept of a time window when the preparation may be overridden by overbooking nor a control of the target cell which may end up cancelling the CHO preparation. In particular, the target cell does not know for how long it may overbook its resources. Furthermore, the target gNB may send CHO cancellation to the source gNB. If the source gNB then again configures the UE and the target gNB for CHO, additional (unnecessary) signalling is required.

Additionally, when preparing the target cell for Conditional Handover, the network doesn't know where the UE is, nor its current speed and direction, nor the earlier trajectory. Accordingly, it does not consider this information in its CHO decision.

Some example embodiments of the invention leverage the location/position information of the UE in the network to improve the conditional handover preparation incl. the UE configuration process.

The source cell may know the UE's location/position. There are plural options how the source cell may know the UE's position/location:
1. UE trajectory prediction performed by the source gNB
   a. a prediction (e.g. probabilistic measure) of a candidate set of beams/cells that the UE is likely to move into
      i. from this a further estimate of predicted target node may be inferred by the source node
   b. an estimate of time before a UE is served by the candidate beam/cell [or a confidence interval]
   c. an estimate of time of stay (TOS) in a candidate beam/cell [or a confidence interval]
2. From another network node (e.g. location management function (LMF), location management component (LMC, Local LMF in RAN) or LCS in MEC, EDGE or Cloud-RAN)
   a. providing the same information as 1b & 1c
   b. running positioning session providing the UE latitude and longitude information
   c. running periodic positioning session providing a list of UE latitude and longitude coordinates over time, e.g. tracking the UE location for UE speed and direction/trajectory.
3. UE measurement report via radio measurements related to serving cell and neighboring cells associated with UE location information, e.g., reference signal received power (RSRP), reference signal received quality (RSRQ), signal over interference and noise ratio (SINR) based on self-optimizing network (SON)/minimization of drive tests (MDT) techniques further enhanced based on successful handover reports (SHR)
4. Moving velocity (assisted by the UE or computed by the network, e.g. by a Doppler estimation)
5. UE History Information IE providing information about served cell history (cell ID, beams) with positional information (e.g. latitude/longitude/altitude) further assisted by TOS information

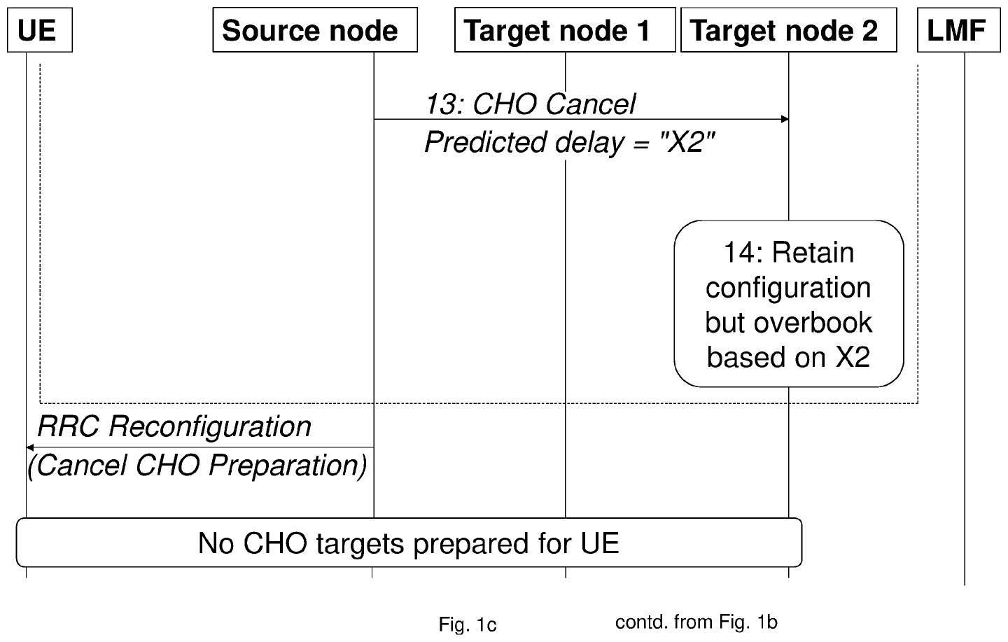

According to some example embodiments of the invention, the determining of the UE's location/position may be triggered by at least one of the following options:
1. As part of CHO decision, the serving gNB may indicate to AMF (for example) to trigger a location service request to LMF (see FIG. 3, actions 4 and 9). LMF will start the NG-RAN and/or UE positioning procedures (3GPP TS 38.305) to find the position of the UE.
2. After receiving the RRC Reconfiguration with CHO command, the UE may trigger a location service request to LMF (see FIG. 3, actions 10 and 11 and actions 14 and 15 as responses). LMF will start the NG-RAN and/or UE positioning procedures (3GPP TS 38.305) to find the position of the UE.

If the source cell has prepared a target cell for CHO of a UE (e.g. due to an earlier measurement report or any other mechanism) and detects or predicts stationarity of the UE from the predicted UE “positions” [e.g. using an algorithm that predicts the UE position or based on a procedure described further below](say for a time window X=100-200 ms). source cell may inform target cell accordingly. CHO resources that are reserved at the target cell can be now overbooked by target gNB for the next X time period. This will allow the target cell to efficiently manage critical resources, e.g. configured grant, GBR.

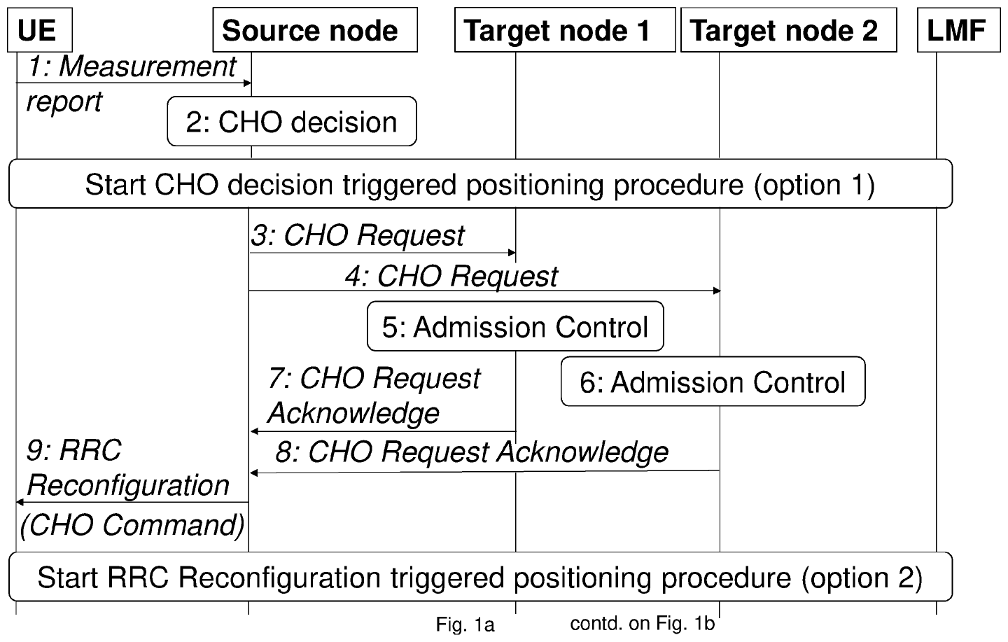

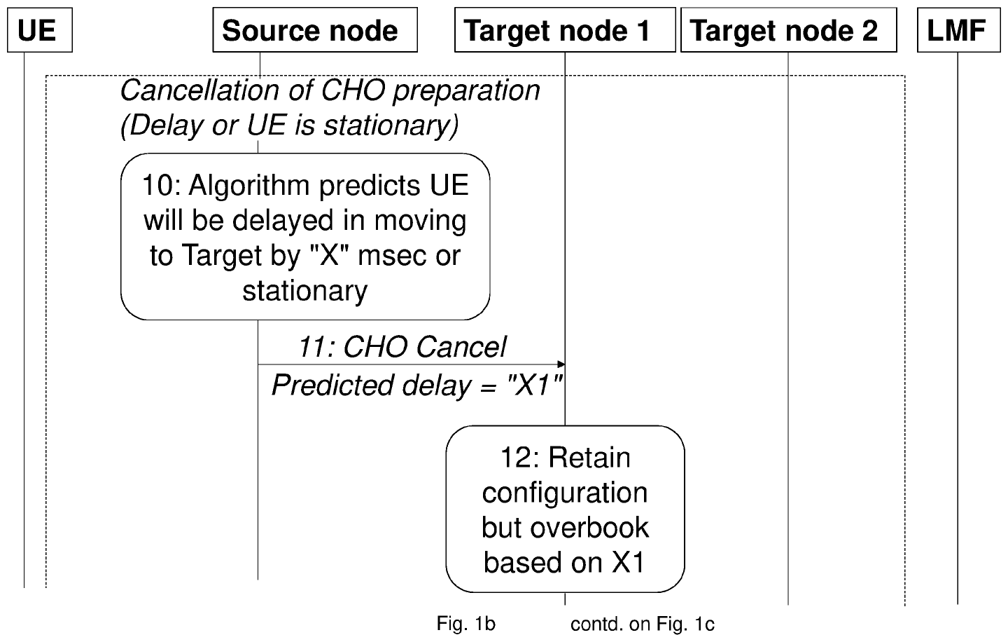

FIGS. 1 and 2 show flow charts of methods 1 and 2 according to some example embodiments of the invention.
Method 1 (FIG. 1): Source gNB triggers CHO cancelation of the resources at the target gNB when the source gNB predicts that the UE will not perform the CHO for at least a predefined time. For example, source gNB may predict that the UE is moving back to the source cell or possibly moving to another target cell or is even stationary.
Method 2 (FIG. 2): Instead of direct cancellation of resources at the target cell, the source cell may negotiate with the target cell on different types of behavior.
   Aspect #1: Source gNB informs target gNB that the UE is stationary/may not arrive in the next X ms or time offset.
      Target can now overbook resources for the next X ms retaining the configuration but releasing the physical resources allocated for the UE.
   Aspect #2: Source gNB will inform the target gNB whenever the UE is mobile or the value of X or the time offset has changed
      Target can now overbook resources for the UE but releasing the physical resources allocated for the UE.

FIG. 1 shows a flow chart according to Method 1 according to some example embodiments of the invention. The actions are as follows:
1: UE provides a measurement report to source cell.
2: Based on the measurement report, source cell decides to configure UE and target cells 1 and 2 for CHO.

(Option 1 for the determining of the UE's location/position, see FIG. 3): Since source cell decides CHO, source cell triggers a positioning procedure to obtain the position/location of the UE.
3, 4: Source cell requests target cells 1 and 2 for CHO of the UE.
5, 6: Target cells 1 and 2 perform admission control and reserve one or more resources for the UE.
7, 8: Target cells 1 and 2 acknowledge the CHO request of 3, 4.
9: Source cell configures UE for CHO (RRC reconfiguration of the UE).

(Option 2 for the determining of the UE's location/position, see FIG. 3): Since UE receives the CHO command of action 9, it triggers a positioning procedure to obtain the position/location of the UE. UE provides at least one of the location/position information of the UE and a prediction based on this location/position information to source cell.

In some example embodiments, only one of options 1 and 2 is performed to obtain the UE's location/position, while in other example embodiments, both options 1 and 2 are performed.

Actions 1 to 9 (without the determining of the UE's location/position according to options 1 and 2) correspond to a conventional CHO procedure.
10: Source cell determines that the UE is stationary or that a handover delay period is larger than a threshold. The threshold may be the same or different for each target cell. The handover delay period indicates a time period for which, according to a prediction based on the location/positioning information, the terminal will likely not perform the conditional handover to the target cell.
11, 13: Source cell cancels the CHO configuration in the target cells because the handover delay period is larger than the threshold. In addition, source cell may inform the target cells on the predicted handover delay period X1 (larger than the threshold).
12, 14: Upon receipt of the CHO cancellation, target cells 1 and 2 may overbook the resources reserved for the UE for the duration of the handover delay period or a portion thereof. Nevertheless, if the CHO cancellation comprises information on the handover delay period, the target cells may retain the UE context for a period X longer than X1. Thus, if the UE performs a (conditional) handover in the period X, signalling effort may be reduced. After the period X, the target gNBs remove the UE context.

Finally, source cell cancels CHO configuration in UE (RRC reconfiguration).

Method 1 is a rather simple method to release the resources in a given target cell when the source cell predicts that the UE will not move into the target cell in the handover delay period X1.

FIG. 2 shows a flow chart of a method 2 according some example embodiments of the invention. Actions 1 to 9 are the same as described for method 1, including the different options for triggering a positioning procedure.

Aspect 1 of method 2 is depicted by actions 10 to 16. According to aspect 1, a finite delay in arrival (i.e., a finite handover delay period) is predicted. A finite handover delay period may include a value of 0 msec.
10 Source cell predicts a respective finite handover delay period X1, X2 for the UE's handover to target cell 1 and target cell 2.
11, 14: Source cell informs target cells 1 and 2 about the respective predicted finite handover delay period, e.g. by mobility update command.
12, 15: Target cells retain the CHO configuration for the UE but may overbook the resources during the respective finite handover delay period (i.e., admit using the resources by another UE), or during a portion of the respective handover delay period (to have some margin if the prediction is erroneous). After the handover delay period (or the portion thereof, respectively), the resources are allocated for the UE again.
13, 16: Response to 11, 14.

Aspect 2a of method 2 is depicted by actions 17 to 23. According to aspect 2a, the source cell predicts that the UE is stationary (infinite large handover delay period).
17: Source cell predicts that the UE is stationary.
18, 21: Source cell informs target cells 1 and 2 about the predicted infinite handover delay period, e.g. by mobility update command. Instead of an indication of an infinite large value, a very large value (e.g. in the order of seconds or more) may be indicated.
19, 22: Target cells retain the CHO configuration for the UE but may overbook the resources until further notice (i.e., admit using the resources by another UE).
20, 23: Response to 20, 23.

Aspect 2b considers the case that the UE, after being predicted to be stationary, becomes predicted to move again such that the handover delay period becomes finite.
24: Source cell informs target cells on the respective finite handover delay period. Then, the target cells may operate as described for aspect 1 of method 2. In particular, if the finite handover delay period is 0 msec, target cell has to reserve resources for the UE immediately (as soon as possible).

Method 2 allows flexible overbooking of physical resources e.g. dedicated contention-free random access preambles, configured grant or GBR. E.g., these resources may be important to support URLLC traffic. Retaining resources for the UE when UE is not going to handover to the target cell is not good from the capacity and spectral efficiency viewpoint. This may be avoided or reduced according to some example embodiments of the invention.

Actions 25 to 34 show conventional execution of the conditional handover.

FIG. 3 shows methods according to options 1 and 2 for triggering a positioning procedure as shown in FIGS. 1 and 2 at greater detail.
1: UE provides a measurement report to source cell.
2: Based on the measurement report, source cell decides to configure UE and target cells 1 and 2 for CHO. The number of target cells is not limited. It may be 1 or more. The target cells may behave differently or in a same way.

(Option 1 for the determining of the UE's location/position, see FIG. 3):
3: Since source cell decides CHO, source cell triggers positioning request with the “CHO based location request” cause value to serving access and mobility function (AMF) for a given target cell.
4 to 7: Location service. Location service may be requested by the gNB to be periodic so that the UE location history, UE speed, UE direction and/or UE trajectory can be obtained.
5 to 6: The LMF instigates location procedures with the source cell and potentially also with neighbouring cells to obtain positioning measurements or assistance data. Also, LMF may instigate procedures with the UE for this purpose.
7: The LMF provides a location service response to the AMF and includes any needed results, e.g. success or failure indication and, if requested and obtained, a location estimate for the UE.
8: Source cell obtains the UE location information from AMF.
9: Source cell sends CHO preparation (RRC reconfiguration) to UE. This command triggers the UE based location process (Option 2).
10: UE requests the location service (e.g. positioning due to RRC Reconfiguration with CHO preparation cause value) or delivery of assistance data to the serving AMF at the non-access stratum (NAS) level.
11 to 14: Location service, same as 4 to 7 in Option 1.
15: AMF returns a location service response to the UE and includes any needed results, e.g. a location estimate for the UE.
16: UE reports the location information to source cell and hence source cell knows it. In some example embodiments, in addition to or instead of reporting the location information to source cell, UE may predict its trajectory based on the location information and provide the predicted trajectory to the source cell.

In some example embodiments, the source cell may inform the target cell on both the predicted delay (handover delay period) and the estimated arrival probability. An example of such handover information is shown in Table 1. Instead of “Infinity”, a very large integer may be indicated for the predicted delay, which may be interpreted as “infinity”.

TABLE 1
Conditional handover information according to some example embodiments of
the invention

| | | | |
|---|---|---|---|
| Conditional Handover | O | | |
| Information | | | |
| >CHO Trigger | M | ENUMERATED (CHO- | |
| | | initiation, CHO-replace, . . . ) | |
| >Target NG-RAN node UE | C- | NG-RAN node UE XnAP ID | Allocated at the target NG- |
| XnAP ID | ifCHOmod | 9.2.3.16 | RAN node |
| >Estimated Arrival | O | INTEGER (1. . . 100) | |
| Probability | | | |
| >Predicted Delay | O | INTEGER | e.g. predicted at the source |
| | | (min_value . . . Infinity) | gNB |

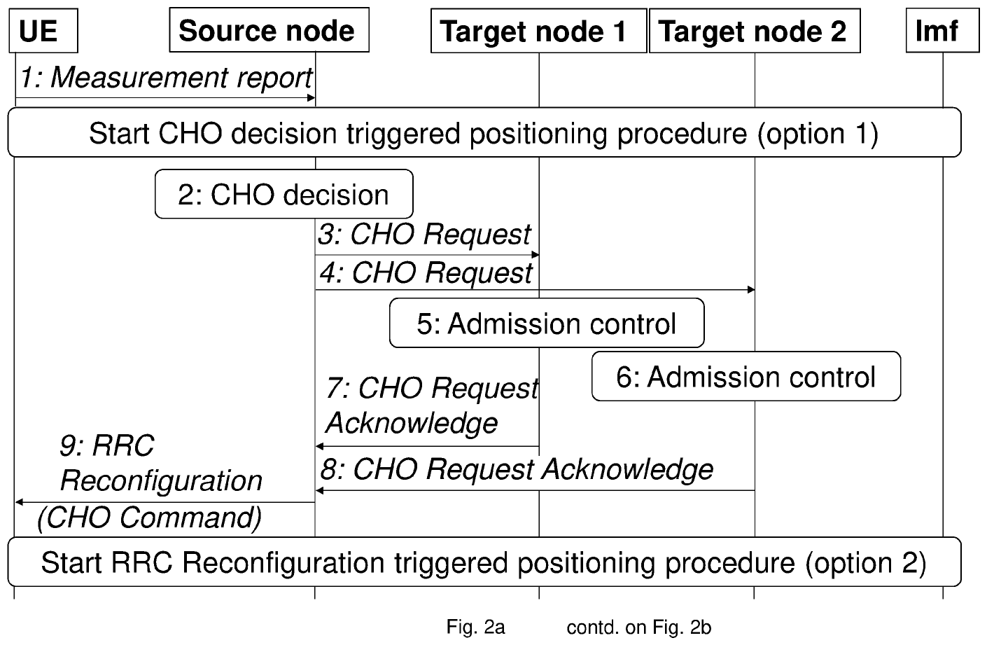

FIG. 4 shows a message chart according to method 3 according to some example embodiments of the invention. In method 3, a given cell (a potential target cell) may estimate a “delay threshold” and share this with its neighbours. This threshold allows:
a source cell to avoid a CHO preparation to the given target cell if the value of the arrival delay (handover delay period) is larger than the “delay threshold”
a source cell to retain/cancel a CHO preparation to the given target cell taking into account one or both of the updated values of the arrival delay (handover delay period) and updated values of the “delay threshold” as time progresses. For example, a source gNB may receive updates on the “delay threshold” from the neighbouring nodes (potential target gNBs) as these nodes may determine that the previous value of the “delay threshold” is no longer applicable. If the source gNB gets this update it may choose to either retain or cancel the CHO preparations of its UEs towards the relevant target nodes based on the update. In this consideration, source gNB may take into account an updated handover delay period, if available. As another option, if source gNB does not receive an update of “delay threshold” but an updated handover delay period, source gNB may decide to either retain or cancel the CHO preparations based on the original “delay threshold” and the updated handover delay period.

In the example embodiment shown in FIG. 4, gNB1 and gNB3 are potential target gNBs for a UE being served by gNB2. Each of them estimates its resource load and determines, based thereon, a respective delay threshold, indicating a maximum time period it is willing to wait that the UE, if configured for CHO to the respective gNB, actually performs the handover. gNB2 receives the delay thresholds and compares them with the respective handover delay period for the UE. If the handover delay period is longer than the respective delay threshold, gNB2 does not configure the UE and the respective one of gNB1 and gNB3 for CHO of the UE.

A resource load may be e.g.
A utilization of downlink and uplink physical resource blocks at the physical layer
load on the computing (CPU) and software processing resources (e.g. memory)
Load on particular software processes e.g. due to MIMO/beamforming processing
Load on the transport interfaces, e.g. backhaul (between gNB's and between gNB and core network) and fronthaul links (between the gNB centralized unit and gNB distributed units)
transmission power on a cell/beam; transmission power may be limited as the power amplifier is usually shared across cells;
etc.

A gNB utilizes the estimate of resource load to determine a holding time for resources that have been allocated for conditional handover preparation of a UE so as to keep the balance between resources dedicated (allocated) to one or more UEs that can be used versus the dedicated resources that are allocated for a future incoming mobility of a UE.

For example, a gNB may determine that its currently served UEs require more resources due to an increased traffic demand in a given time period. This implies that any resources reserved for UE(s) with CHO preparations cannot be reserved within the time period corresponding to the increased traffic demand. Consequently, the initial estimate of time for which the resources reserved for UE(s) with CHO preparations (holding time) can be kept has to be updated in accordance (or based on a function of) with the time period of the increased traffic demand.

The actions in FIG. 4 are as follows:

Scenario (Stage) 1: Estimating and sharing of delay thresholds
1, 5: gNB1 and gNB3 estimate their resource load and, based thereon, determine a respective delay threshold.
2, 6: gNB1 and gNB3 provide their respective delay threshold to gNB2. For example, they may use Mobility Update command.
3, 7: gNB2 stores the received delay thresholds. Thus, gNB2 is prepared.
4, 8: response to actions 2, 6.

Scenario (Stage) 2 (following scenario (stage) 1): CHO preparation
9: UE being served by gNB2 sends a measurement report for cell 1 (represented by gNB1 in FIG. 4) and cell 3 (represented by gNB3 in FIG. 4) (a respective cell thereof. For example, based on the measurement report, gNB meets a preliminary decision that the UE and gNB1 and gNB2 should be prepared for CHO of the UE. In addition, it estimates a predicted delay (handover delay period) for the handover to gNB1 and a predicted delay for the handover to gNB3. This estimation may be performed in the same way as discussed for methods 1 and 2.
10, 11: gNB2 compares the predicted delays (handover delay periods) with the corresponding delay thresholds. For gNB1, the predicted delay is larger than the delay threshold shared by gNB1. For gNB3, the predicted delay is smaller than the delay threshold shared by gNB3.
12: Because the predicted delay for gNB1 is larger than the delay threshold for gNB1, gNB2 does not prepare the UE and gNB1 for CHO of the UE to gNB1.
13: Because the predicted delay for gNB3 is smaller than the delay threshold for gNB3, gNB2 may prepare the UE and gNB3 for CHO of the UE to gNB3.

Scenario (Stage) 3 (following scenario (stage) 2, or following directly scenario (stage) 1 (i.e., scenario (stage) 2 may be skipped)): Conditional CHO cancellation
14: gNB2 has prepared UE and gNB3 for CHO of the UE to gNB3 (according to scenario (stage) 2 or without taking into account the delay threshold and/or the handover delay period).
15 to 18 correspond to actions 5 to 8:
15: gNB3 estimates its resource load and, based thereon, determines a delay threshold.
16: gNB3 provides its delay threshold to gNB2. For example, it may use Mobility Update command.
17: gNB2 stores the received delay threshold. Thus, gNB2 is prepared.
18: response to action 16.
19: gNB2 compares the predicted delay (handover delay period) for the handover of the UE to gNB3 with the delay threshold provided by gNB3. The predicted delay may be based on the same prediction as that made when the CHO preparation was performed, or the predicted delay may be based on a more recent prediction. For example, the receipt of the delay threshold from gNB3 in action 16 may trigger the generation of a new prediction. For gNB3, the predicted delay is larger than the delay threshold shared by gNB3.
20: Since for gNB3, the predicted delay is larger than the delay threshold shared by gNB3, gNB2 cancels CHO to gNB3 in both the UE and gNB3.

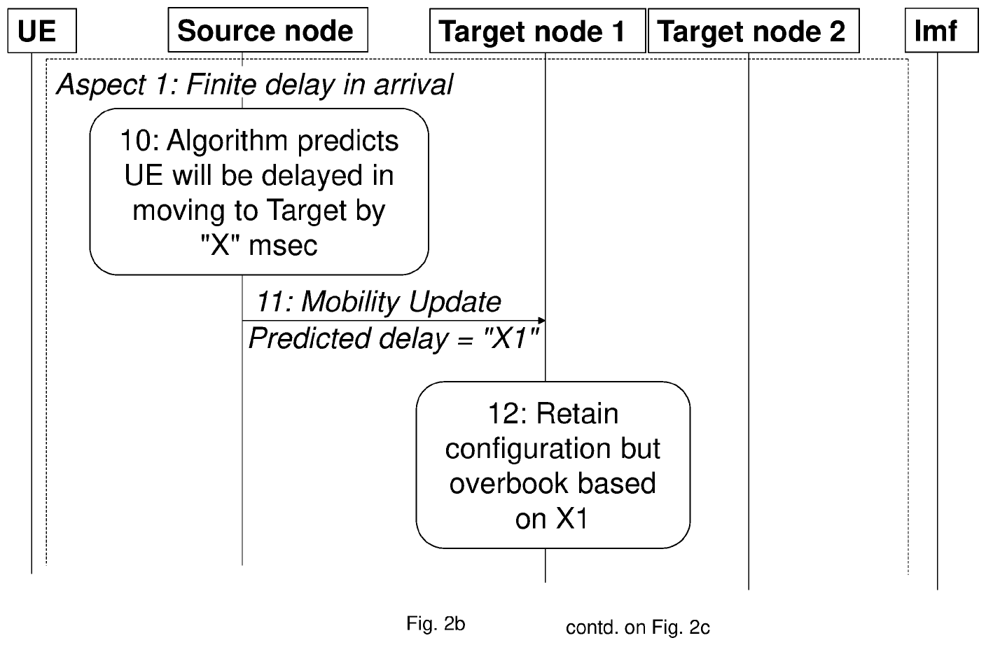

FIG. 5 shows a method 4 according to a further example embodiment of the invention. In method 4, a target gNB provides a feedback of the real “arrival delay” after a successful handover of a given UE at the target gNB. The source gNB may use the real “arrival delay” and compare it against the predicted delay (handover delay period) “X” and use it for the purposes of reinforcement learning or tuning the prediction algorithm itself.

The actions in FIG. 5 are as follows:
1: gNB1 (source gNB) prepares CHO of UE towards target gNB (gNB2), e.g. according to method 1 or method 2. It stores the predicted delay (handover delay period) “X” for this handover together with a time stamp for the prediction.
2: When the handover of the UE to gNB2 is completed, gNB2 records the timestamp of completion. Instead of the time stamp of handover completion, depending on implementation, any other action in the actual handover procedure (e.g. any of those of actions 27 to 34 of FIG. 2) may be used to trigger recording of the time stamp.
3: Target gNB (gNB2) reports the recorded time stamp to the source gNB (gNB1). For example, gNB2 may use a Handover Success Computed actual delay command.
4: Based on the predicted delay and the actual delay, source gNB may update the prediction.

In action 2, if a signalling message sent or received by the source gNB (such as action 30: Handover success in FIG. 2) is used to trigger recording of the time stamp, source gNB may determine the actual delay without receiving an explicit indication from the target gNB. In such implementations, action 3 may be omitted.

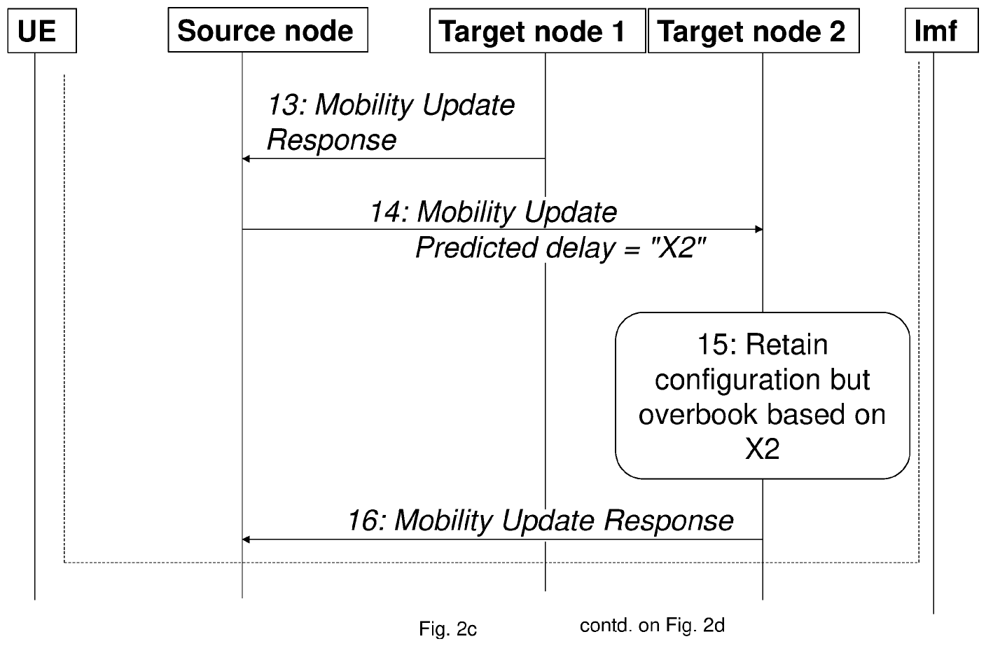

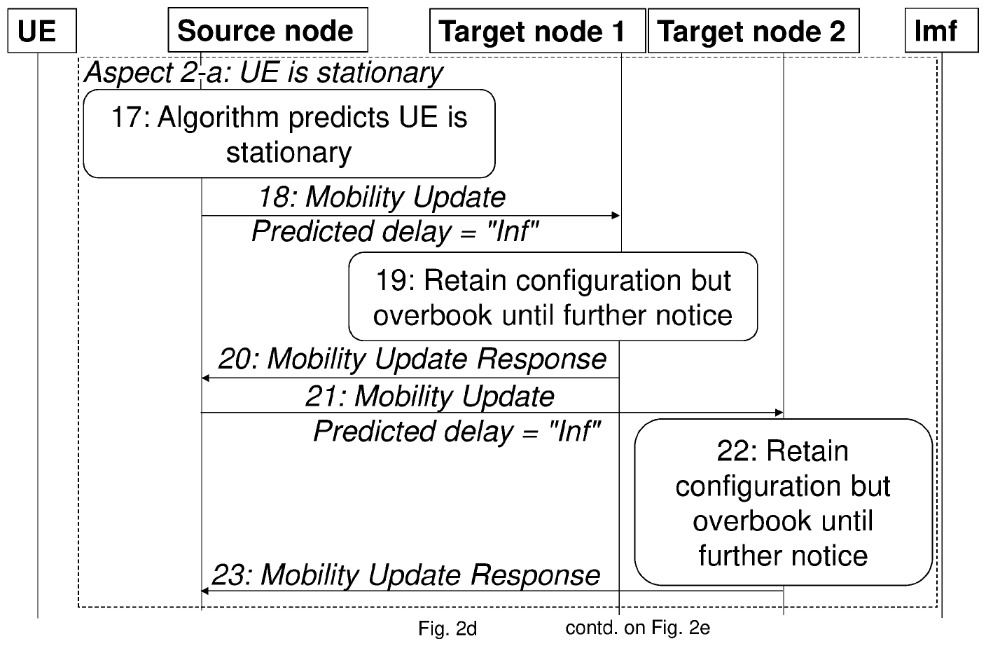

FIG. 6 shows an apparatus according to an example embodiment of the invention. The apparatus may be a base station (in particular: a source base station), such as a gNB or an eNB, or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for monitoring 120, means for estimating 130, and means for informing 140. The means for monitoring 120, means for estimating 130, and means for informing 140 may be a monitoring means, estimating means, and informing means, respectively. The means for monitoring 120, means for estimating 130, and means for informing 140 may be a monitor, estimator, and informer, respectively. The means for monitoring 120, means for estimating 130, and means for informing 140 may be a monitoring processor, estimating processor, and informing processor, respectively.

The means for monitoring 120 monitors whether a source cell configures a terminal and a target cell for a conditional handover of the terminal from the source cell to the target cell (S120). If the source cell configures the terminal and the target cell for the conditional handover (S120=yes), the means for estimating 130 estimates a handover delay period (S130). The handover delay period indicates a time period for which, according to a prediction of a likely future movement of the terminal, the terminal will likely not perform the conditional handover to the target cell. For example, the prediction may be available to the means for monitoring 120 anyway (because it was prepared for some other purpose), or the means for monitoring 120 may obtain the prediction. E.g., the apparatus may generate the prediction based on some history data, or the apparatus may receive the prediction from another device, from the management system (e.g., OAM if it has implemented a positioning/location based on the data received from self-organizing network (SON)/minimization of drive tests (MDT)) or from the core network. The means for informing 140 informs the target cell on the handover delay period (S140).

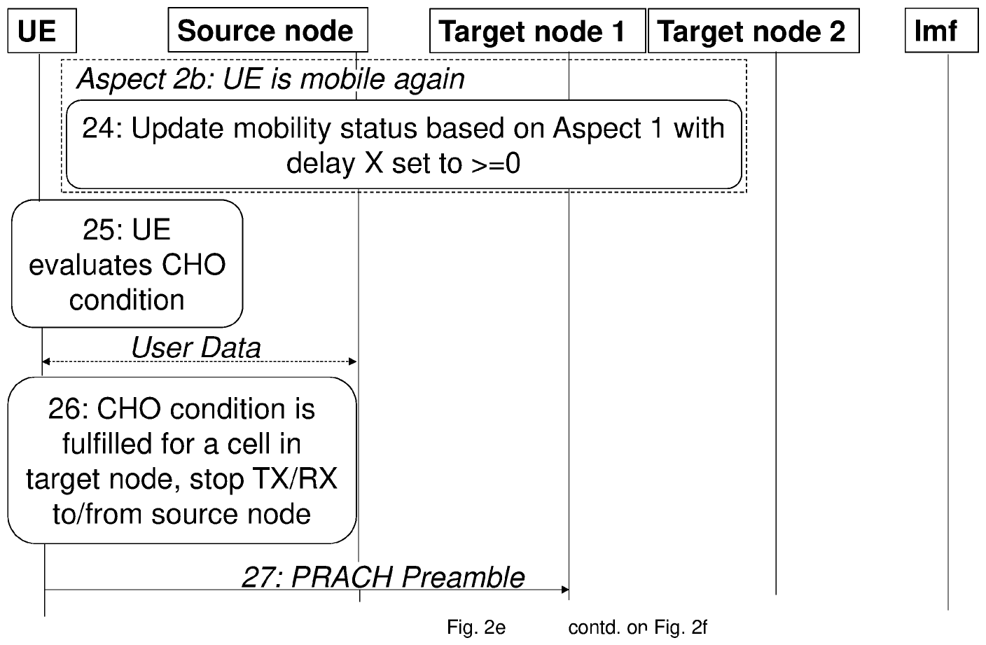

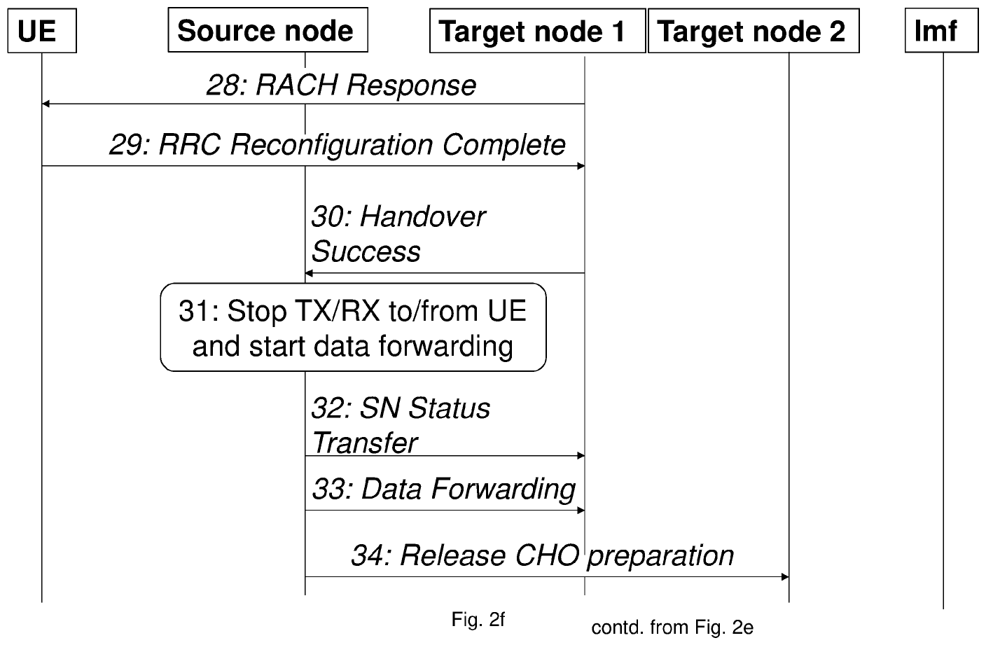

FIG. 8 shows an apparatus according to an example embodiment of the invention. The apparatus may be a base station (in particular: a source base station), such as a gNB or an eNB, or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for monitoring 220, means for estimating 230, means for checking 240, and means for cancelling 250. The means for monitoring 220, means for estimating 230, means for checking 240, and means for cancelling 250 may be a monitoring means, estimating means, checking means, and cancelling means, respectively. The means for monitoring 220, means for estimating 230, means for checking 240, and means for cancelling 250 may be a monitor, estimator, checker, and canceller, respectively. The means for monitoring 220, means for estimating 230, means for checking 240, and means for cancelling 250 may be a monitoring processor, estimating processor, checking processor, and cancelling processor, respectively.

The means for monitoring 220 monitors whether a source cell configures a terminal and a target cell for a conditional handover of the terminal from the source cell to the target cell (S220). If the source cell configures the terminal and the target cell for the conditional handover (S220=yes), the means for estimating 230 estimates a handover delay period (S230). The handover delay period indicates a time period for which, according to a prediction of a likely future movement of the terminal, the terminal will likely not perform the conditional handover to the target cell. For example, the prediction may be available to the means for monitoring 220 anyway (because it was prepared for some other purpose), or the means for monitoring 220 may obtain the prediction. E.g., the apparatus may generate the prediction based on some history data, or the apparatus may receive the prediction from another device.

The means for checking 240 checks whether the handover delay period is larger than a predefined threshold (S240). If the handover delay period is longer than the predefined threshold (S240=yes), the means for cancelling 250 cancels the conditional handover (S250).

Some example embodiments of the invention combine the apparatuses of FIGS. 6 and 8 such that the means for obtaining 110, 210, means for monitoring 120, 220, and means for estimating 130, 230 are the same. The same applies correspondingly to the methods of FIGS. 7 and 9.

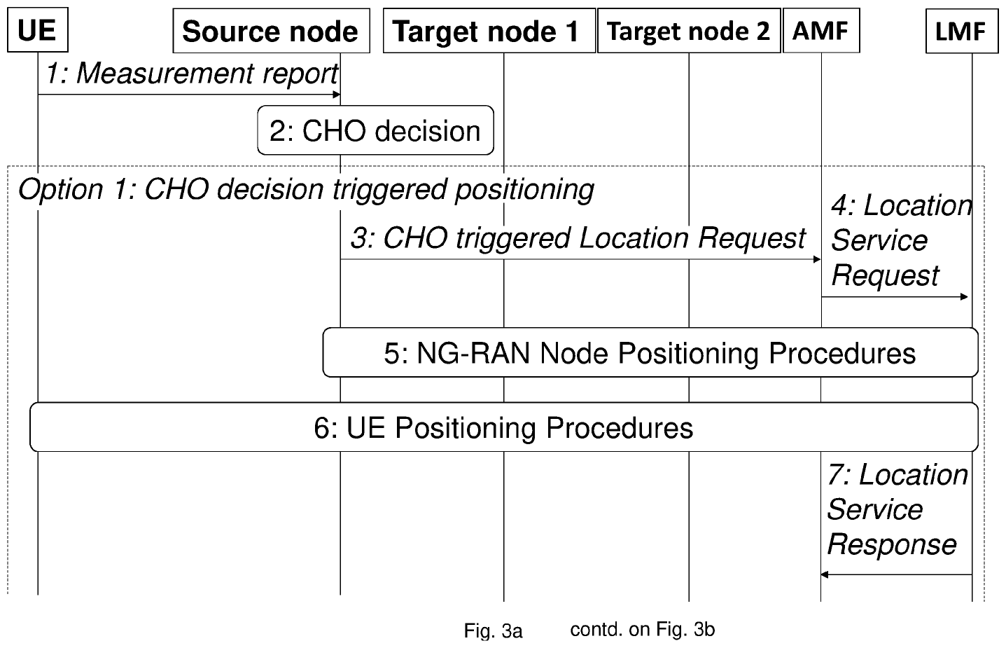

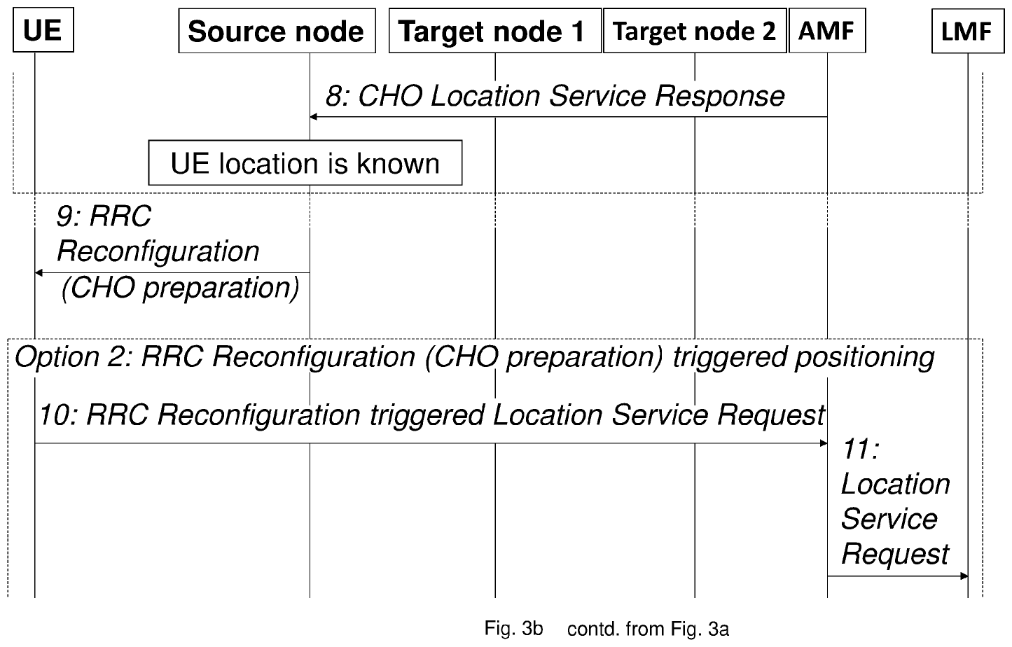

FIG. 10 shows an apparatus according to an example embodiment of the invention. The apparatus may be a base station (in particular: a target base station), such as a gNB or an eNB, or an element thereof. FIG. 11 shows a method according to an example embodiment of the invention. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises means for supervising 310, means for monitoring 320, and means for controlling 330. The means for supervising 310, means for monitoring 320, and means for controlling 330 may be a supervising means, monitoring means, and controlling means, respectively. The means for supervising 310, means for monitoring 320, and means for controlling 330 may be a supervisor, monitor, and controller, respectively. The means for supervising 310, means for monitoring 320, and means for controlling 330 may be a supervising processor, monitoring processor, and controlling processor, respectively.

The means for supervising 310 supervises whether a target cell is configured, by a source cell, for a conditional handover of a first terminal from the source cell to the target cell (S310). The configuring of the target cell for the conditional handover of the first terminal comprises reserving a resource of the target cell for the first terminal.

The means for monitoring 320 monitors whether an information on a handover delay period for the conditional handover is received from the source cell (S320). The handover delay period indicates a time period for which the first terminal will likely not perform the conditional handover to the target cell.

S310 and S320 may be performed in an arbitrary sequence. They may be performed fully or partly in parallel.

If the target cell is configured for the conditional handover of the first terminal (S310=yes) and the information on the handover delay period is received (S320=yes), the means for controlling 330 controls the resource of the target cell in accordance with the handover delay period (S330). For example, the target cell may overbook the resource during the handover delay period.

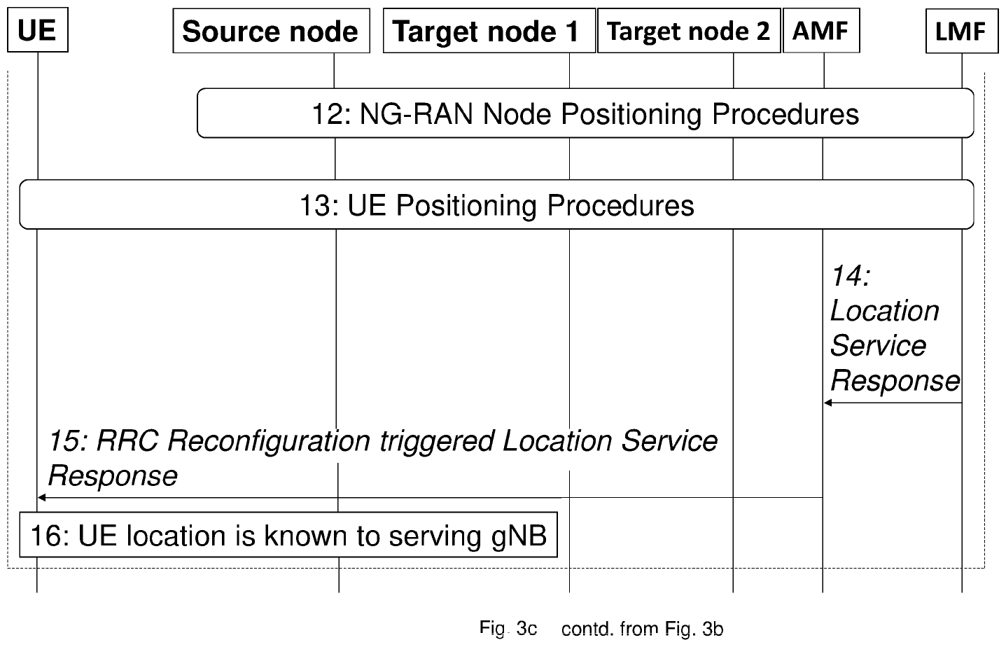

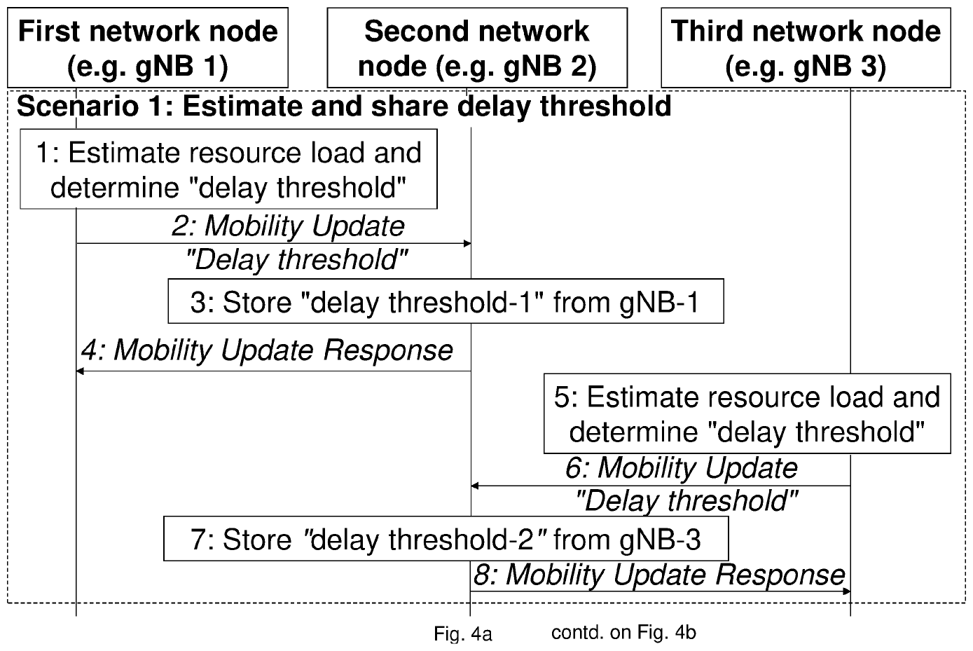

FIG. 12 shows an apparatus according to an example embodiment of the invention. The apparatus may be a terminal, such as a UE or an MTC device, or an element thereof. FIG. 13 shows a method according to an example embodiment of the invention. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises means for monitoring 410, means for requesting 420, and means for providing 430. The means for monitoring 410, means for requesting 420, and means for providing 430 may be a monitoring means, requesting means, and providing means, respectively. The means for monitoring 410, means for requesting 420, and means for providing 430 may be a monitor, request, and provider, respectively. The means for monitoring 410, means for requesting 420, and means for providing 430 may be a monitoring processor, requesting processor, and providing processor, respectively.

The means for monitoring 410 monitors whether a terminal is configured for conditional handover from a source cell to a target cell (S410). If the terminal is configured for the conditional handover (S410=yes), the means for requesting 420 requests at least one of (S420)
an estimation of a location of the terminal together with an estimation of a speed and a movement direction of the terminal and
estimations of locations of the terminal at different points in time.

The means for providing 430 provides to the source cell (S430) the at least one of
the estimation of the location of the terminal together with the estimation of the speed of the terminal and the movement direction of the terminal and
the estimations of the locations of the terminal at different points in time.

This at least one estimation is received in response to the requesting of S420.

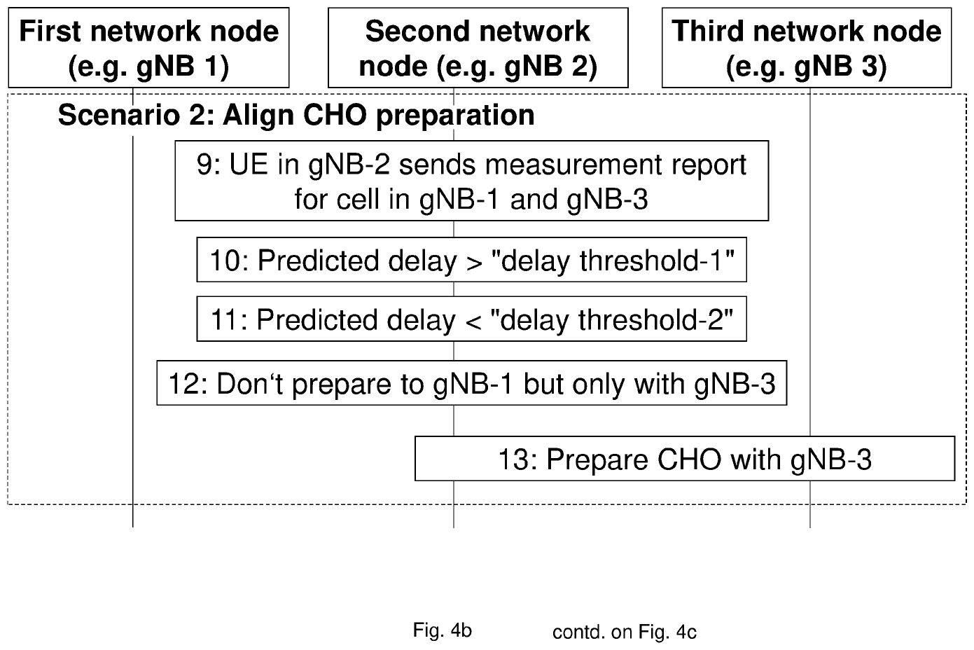

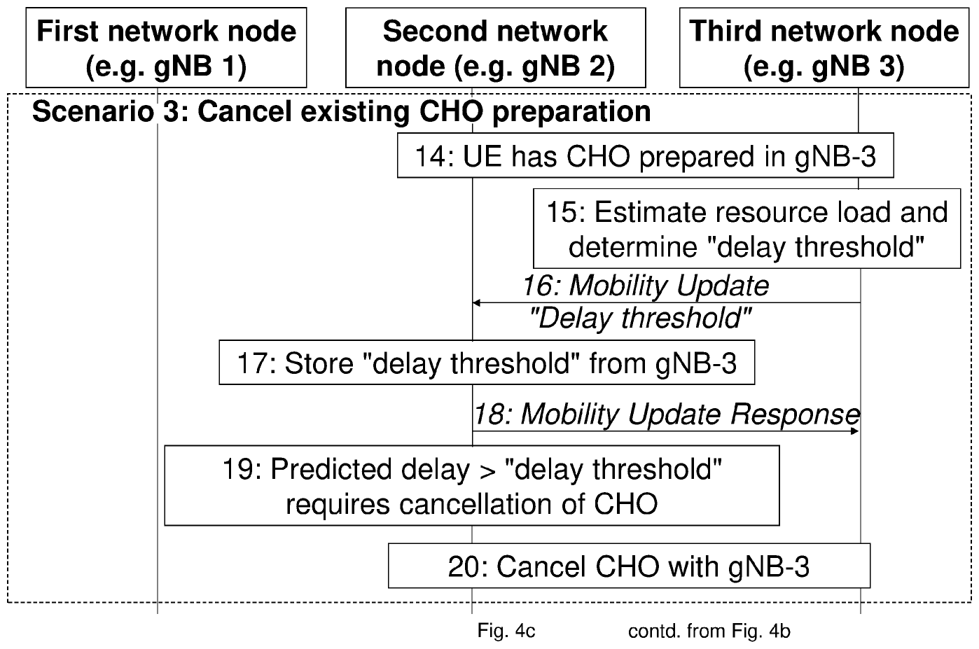

FIG. 14 shows an apparatus according to an example embodiment of the invention. The apparatus may be a terminal, such as a UE or an MTC device, or an element thereof. FIG. 15 shows a method according to an example embodiment of the invention. The apparatus according to FIG. 14 may perform the method of FIG. 15 but is not limited to this method. The method of FIG. 15 may be performed by the apparatus of FIG. 14 but is not limited to being performed by this apparatus.

The apparatus comprises means for monitoring 510, means for requesting 520, means for generating 530, and means for providing 540. The means for monitoring 510, means for requesting 520, means for generating 530, and means for providing 540 may be a monitoring means, requesting means, generating means, and providing means, respectively. The means for monitoring 510, means for requesting 520, means for generating 530, and means for providing 540 may be n monitor, request, generator, and provider, respectively. The means for monitoring 510, means for requesting 520, means for generating 530, and means for providing 540 may be a monitoring processor, requesting processor, generating processor, and providing processor, respectively.

The means for monitoring 510 monitors whether a terminal is configured for conditional handover from a source cell to a target cell (S510). If the terminal is configured for the conditional handover (S510=yes), the means for requesting 520 requests at least one of (S520)
an estimation of a location of the terminal together with an estimation of a speed and a movement direction of the terminal and
estimations of locations of the terminal at different points in time.

The means for generating 530 generates a prediction of a likely future movement of the terminal (S530) based on the at least one of
the estimation of the location of the terminal together with the estimation of the speed of the terminal and the movement direction of the terminal and
the estimations of the locations of the terminal at different points in time.

This at least one estimation is received in response to the requesting of S520. The means for providing 540 provides the prediction to the source cell (S540).

Some example embodiments of the invention combine the apparatuses of FIGS. 12 and 14 such that the means for monitoring 410, 510 and means for requesting 420, 520 are the same. The same applies correspondingly to the methods of FIGS. 13 and 15.

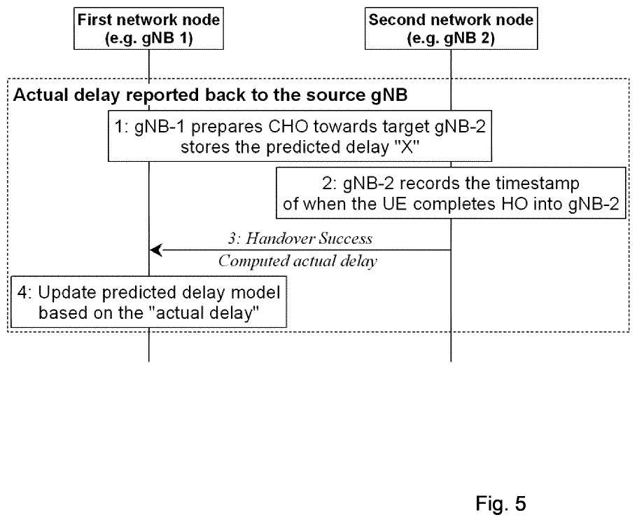

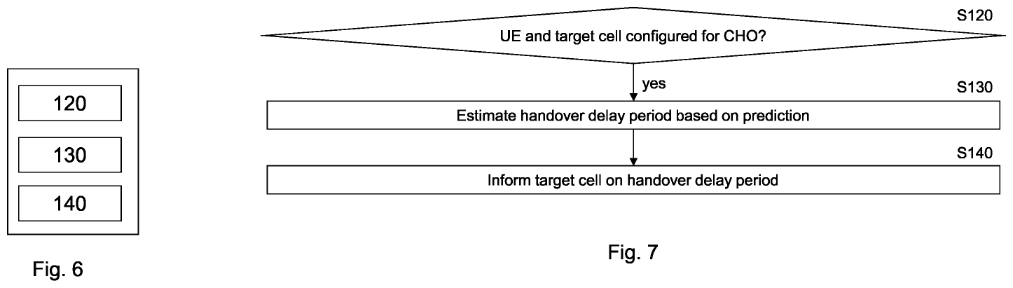

FIG. 16 shows an apparatus according to an example embodiment of the invention. The apparatus may be a base station (in particular: a source base station), such as a gNB or an eNB, or an element thereof. FIG. 17 shows a method according to an example embodiment of the invention. The apparatus according to FIG. 16 may perform the method of FIG. 17 but is not limited to this method. The method of FIG. 17 may be performed by the apparatus of FIG. 16 but is not limited to being performed by this apparatus.

The apparatus comprises means for estimating 620, means for monitoring 630, means for checking 640, and means for inhibiting 650. The means for estimating 620, means for monitoring 630, means for checking 640, and means for inhibiting 650 may be an estimating means, monitoring means, checking means, and inhibiting means, respectively. The means for estimating 620, means for monitoring 630, means for checking 640, and means for inhibiting 650 may be an estimator, monitor, checker, and inhibiter, respectively. The means for estimating 620, means for monitoring 630, means for checking 640, and means for inhibiting 650 may be an estimating processor, monitoring processor, checking processor, and inhibiting processor, respectively.

The means for estimating 620 estimates an assumed handover delay period (S620). The assumed handover delay period indicates a time period for which, according to a prediction of a likely future movement of a terminal, the terminal will likely not perform a conditional handover from a source cell to a target cell under the assumption that the source cell configures the terminal and the target cell for the conditional handover. For example, the prediction may be available to the means for estimating 620 anyway (because it was prepared for some other purpose), or the means for estimating 620 may obtain the prediction. E.g., the apparatus may generate the prediction based on some history data, or the apparatus may receive the prediction from another device, management system (e.g., OAM if it has implemented a positioning/location based on the data received from self-organizing network (SON)/minimization of drive tests (MDT)) or from the core network.

The means for monitoring 630 monitors whether the source cell receives a first delay threshold from the target cell (S630).

S630 and the sequence of S610 and S620 may be performed in an arbitrary sequence. They may be performed fully or partly in parallel.

If the source cell receives the first delay threshold (S630=yes), the means for checking 640 checks whether the assumed handover delay period is larger than the first delay threshold (S640). If the assumed handover delay period is larger than the first delay threshold (S640=yes), the means for inhibiting 650 inhibits the configuring the terminal and the target cell for the conditional handover (S650).

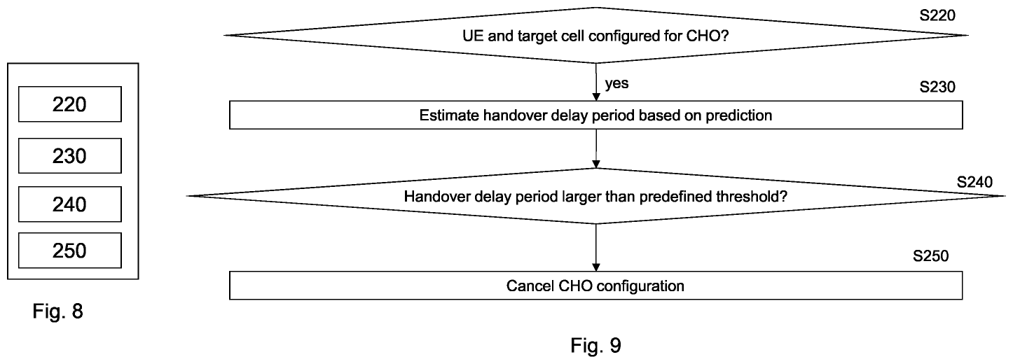

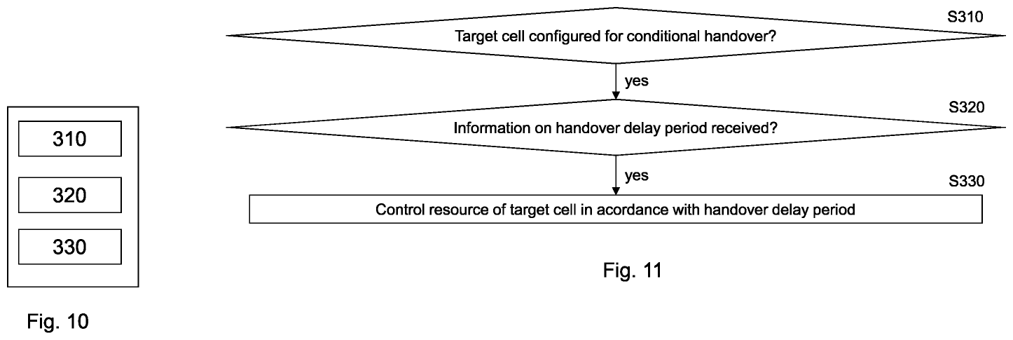

FIG. 18 shows an apparatus according to an example embodiment of the invention. The apparatus may be a base station (in particular: a source base station), such as a gNB or an eNB, or an element thereof. FIG. 19 shows a method according to an example embodiment of the invention. The apparatus according to FIG. 18 may perform the method of FIG. 19 but is not limited to this method. The method of FIG. 19 may be performed by the apparatus of FIG. 18 but is not limited to being performed by this apparatus.

The apparatus comprises means for determining 720, means for estimating 730, means for monitoring 740, means for checking 750, and means for cancelling 760. The means for determining 720, means for estimating 730, means for monitoring 740, means for checking 750, and means for cancelling 760 may be a determining means, estimating means, monitoring means, checking means, and cancelling means, respectively. The means for determining 720, means for estimating 730, means for monitoring 740, means for checking 750, and means for cancelling 760 may be a determiner, estimator, monitor, checker, and canceller, respectively. The means for determining 720, means for estimating 730, means for monitoring 740, means for checking 750, and means for cancelling 760 may be a determining processor, estimating processor, monitoring processor, checking processor, and cancelling processor, respectively.

The means for determining 720 determines whether a terminal and a target cell have been configured for a conditional handover of the terminal from a source cell to the target cell (S720).

If the terminal and the target cell have been configured for the conditional handover (S720=yes), the means for estimating 730 estimates a handover delay period (S730). The handover delay period indicates a time period for which, according to a prediction of a likely future movement of the terminal, the terminal will likely not perform the conditional handover from the source cell to the target cell. For example, the prediction may be available to the means for estimating 730 anyway (because it was prepared for some other purpose), or the means for estimating 730 may obtain the prediction. E.g., the apparatus may generate the prediction based on some history data, or the apparatus may receive the prediction from another device, management system (e.g., OAM if it has implemented a positioning/location based on the data received from self-organizing network (SON)/minimization of drive tests (MDT)) or from the core network.

The means for monitoring 740 monitors whether the source cell receives a delay threshold from the target cell (S740). If the source cell receives the delay threshold (S740=yes), the means for checking 750 checks whether the (estimated) handover delay period of S730 is larger than the delay threshold (S750). If the assumed handover delay period is larger than the delay threshold (S750=yes), the means for cancelling 760 cancels the configuration of the terminal and the target cell for the conditional handover (S760).

S740 and the sequence of S720 to S730 may be performed in an arbitrary sequence. they may be performed fully or partly in parallel.

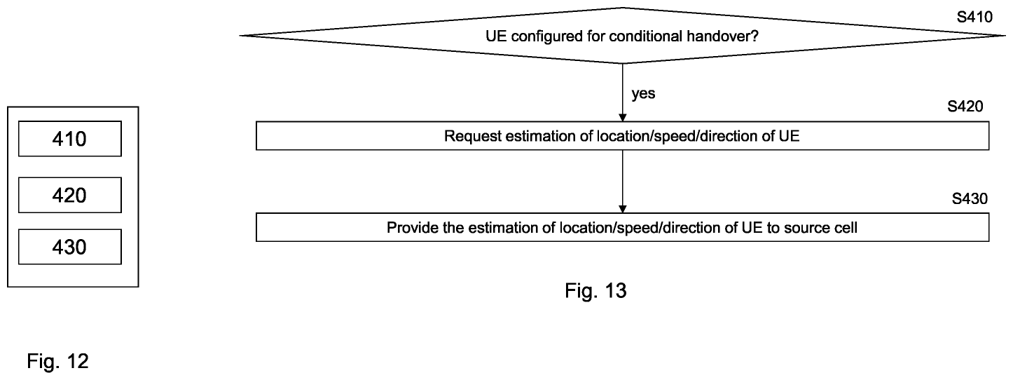

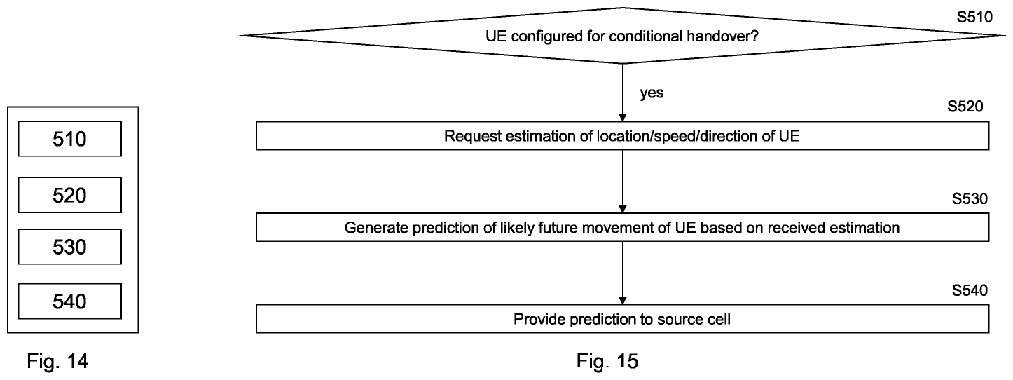

FIG. 20 shows an apparatus according to an example embodiment of the invention. The apparatus may be a base station (in particular: a target base station), such as a gNB or an eNB, or an element thereof. FIG. 21 shows a method according to an example embodiment of the invention. The apparatus according to FIG. 20 may perform the method of FIG. 21 but is not limited to this method. The method of FIG. 21 may be performed by the apparatus of FIG. 20 but is not limited to being performed by this apparatus.

The apparatus comprises means for determining 820 and means for informing 830. The means for determining 820 and means for informing 830 may be a determining means and informing means, respectively. The means for determining 820 and means for informing 830 may be a determiner and informer, respectively. The means for determining 820 and means for informing 830 may be a determining processor and informing processor, respectively.

The means for determining 820 determines a handover delay threshold based on an estimated load of resources of a target cell (S820). The handover delay threshold indicates a maximum acceptable time (from the viewpoint of the target cell) for a delay between a time when the target cell is configured for a conditional handover of a terminal from a source cell to the target cell and a time when the terminal executes the conditional handover. The means for informing 830 informs the source cell on the handover delay threshold (S830).

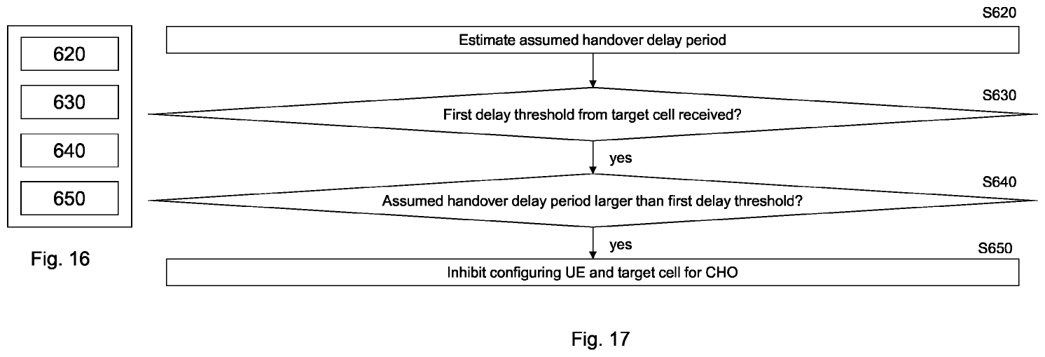

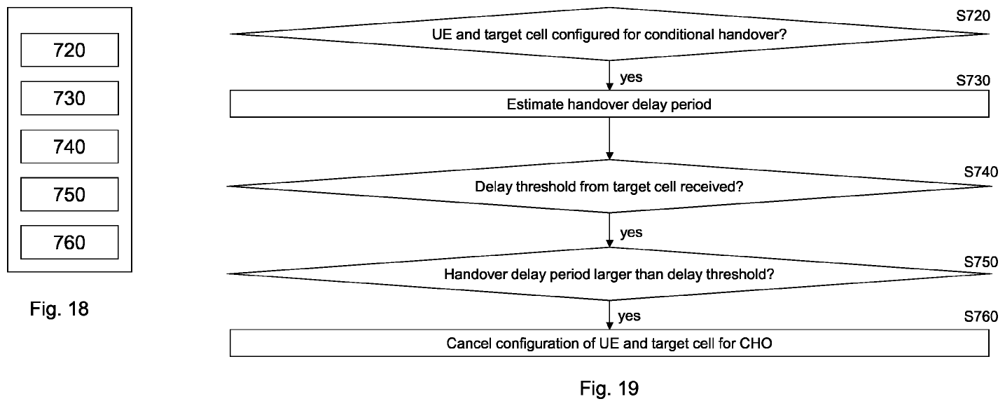

FIG. 22 shows an apparatus according to an example embodiment of the invention. The apparatus may be a base station (in particular: a source base station), such as a gNB or an eNB, or an element thereof. FIG. 23 shows a method according to an example embodiment of the invention. The apparatus according to FIG. 22 may perform the method of FIG. 23 but is not limited to this method. The method of FIG. 23 may be performed by the apparatus of FIG. 22 but is not limited to being performed by this apparatus.

The apparatus comprises means for monitoring 920, means for estimating 930, means for supervising 940, and means for adapting 950. The means for monitoring 920, means for estimating 930, means for supervising 940, and means for adapting 950 may be a monitoring means, estimating means, supervising means, and adapting means, respectively. The means for monitoring 920, means for estimating 930, means for supervising 940, and means for adapting 950 may be a monitor, estimator, supervisor, and adapter, respectively. The means for monitoring 920, means for estimating 930, means for supervising 940, and means for adapting 950 may be a monitoring processor, estimating processor, supervising processor, and adapting processor, respectively.

The means for monitoring 920 monitors whether a source cell configures a terminal and a target cell for a conditional handover of the terminal from the source cell to the target cell (S920). If the source cell configures the terminal and the target cell for the conditional handover (S920=yes), the means for estimating 930 estimates a handover delay period (S930). The handover delay period indicates a time period for which, according to a prediction of a likely future movement of the terminal, the terminal will likely not perform the conditional handover to the target cell. For example, the prediction may be available to the means for estimating 930 anyway (because it was prepared for some other purpose), or the means for estimating 930 may obtain the prediction. E.g., the apparatus may generate the prediction based on some history data, or the apparatus may receive the prediction from another device, management system (e.g., OAM if it has implemented a positioning/location based on the data received from self-organizing network (SON)/minimization of drive tests (MDT)) or from the core network.

The means for supervising 940 supervises whether the source cell obtains an indication of an actual delay of the conditional handover (S940). The source cell may obtain the indication of the actual delay from a message received from the target cell or based on a command to or from the source cell transmitted for the actual execution of the handover. If the source cell obtains the indication of the actual delay (S940=yes), the means for adapting 950 adapts the prediction based on the actual delay and the handover delay period, i.e. the predicted delay (S950).

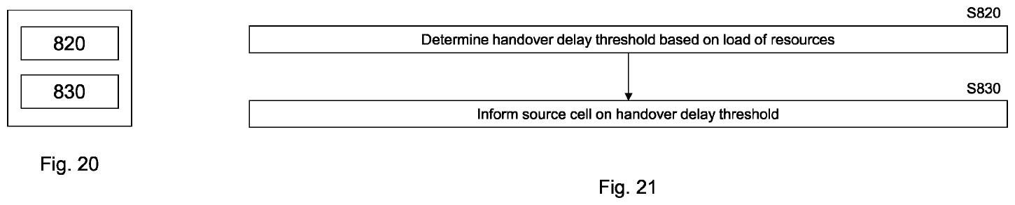

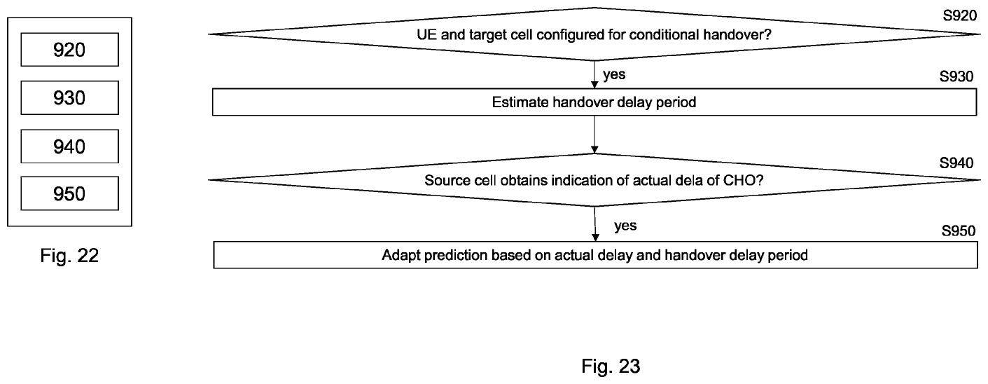

FIG. 24 shows an apparatus according to an example embodiment of the invention. The apparatus may be a base station (in particular: a target base station), such as a gNB or an eNB, or an element thereof. FIG. 25 shows a method according to an example embodiment of the invention. The apparatus according to FIG. 24 may perform the method of FIG. 25 but is not limited to this method. The method of FIG. 25 may be performed by the apparatus of FIG. 24 but is not limited to being performed by this apparatus.

The apparatus comprises means for monitoring 1010 and means for providing 1020. The means for monitoring 1010 and means for providing 1020 may be a monitoring means and providing means, respectively. The means for monitoring 1010 and means for providing 1020 may be a monitor and provider, respectively. The means for monitoring 1010 and means for providing 1020 may be a monitoring processor and providing processor, respectively.

The means for monitoring 1010 monitors whether a terminal performs a conditional handover from a source cell to a target cell after the source cell configured the target cell for the conditional handover (S1010). If the terminal performs the conditional handover (S1010=yes), the means for providing 1020 provides, to the source cell, an indication of a delay between a first time when the source cell configured the target cell for the conditional handover and a second time when the terminal performs the conditional handover (S1020).

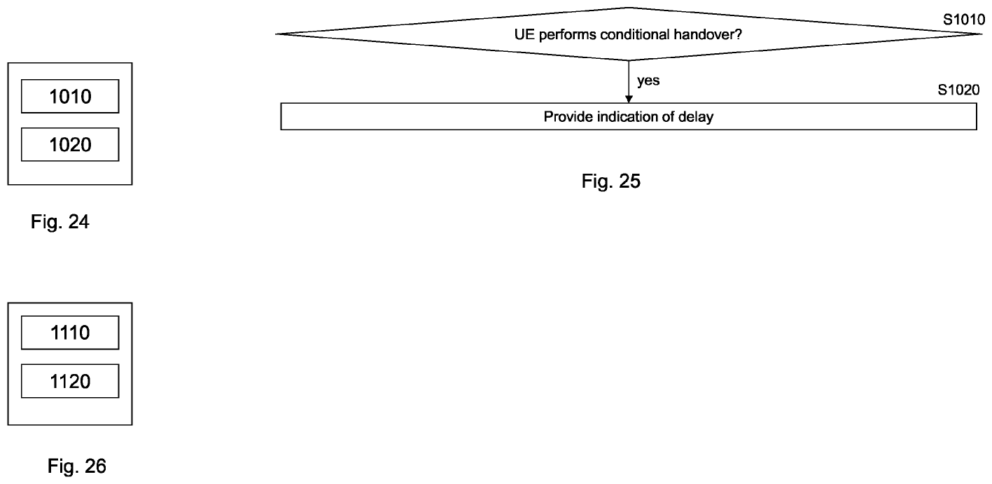

FIG. 26 shows an apparatus according to an embodiment of the invention. The apparatus comprises at least one processor 1110, at least one memory 1120 including computer program code, and the at least one processor 1110, with the at least one memory 1120 and the computer program code, being arranged to cause the apparatus to at least perform at least the method according to at least one of FIGS. 7, 9, 11, 13, 15, 17, 19, 21, 23, and 25 and related description.

The number of target cells is not limited. The number of target cells may be 1 or more (e.g. 2, as shown in the example embodiments of FIGS. 1 to 4). The target cells may behave differently or in a same way.

Some example embodiments are explained with respect to a 5G network. However, the invention is not limited to 5G. It may be used in other radio networks, too, e.g. in previous of forthcoming generations of 3GPP networks such as 4G, 6G, or 7G, etc. It may be used in non-3GPP mobile communication networks if a conditional handover is available.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a terminal (such as a UE or a MTC device) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a base station (such as a gNB or eNB) representing a cell or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The phrase “at least one of A and B” comprises the options only A, only B, and both A and B. The terms “first X” and “second X” include the options that “first X” is the same as “second X” and that “first X” is different from “second X”, unless otherwise specified.

1.-31. (canceled)

32. An apparatus comprising:
one or more processors, and memory storing instructions that, when executed by the one or more processors, cause the apparatus to perform:
monitoring whether a source cell has configured a terminal and a target cell for a conditional handover of the terminal from the source cell to the target cell;
estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell; and at least one of
informing the target cell on the handover delay period; and
checking whether the handover delay period is larger than a predefined threshold; and cancelling the conditional handover configuration of the terminal and the target cell if the handover delay period is longer than the predefined threshold.

33. The apparatus according to claim 32, wherein the instructions, when executed by the one or more processors, further cause the apparatus to perform:
checking whether, according to the prediction, the terminal is stationary;
setting the handover delay period to a predefined large value.

34. The apparatus according to claim 32, wherein the instructions, when executed by the one or more processors, further cause the apparatus to perform at least one of:
obtaining the prediction of the likely future movement of the terminal.

35. The apparatus according to claim 34, wherein the instructions, when executed by the one or more processors, further cause the apparatus to perform at least one of:
the obtaining the prediction by generating the prediction based on at least one of an estimation of a location of the terminal together with an estimation of a speed of the terminal and a movement direction of the terminal and estimations of locations of the terminal at different points in time; and
the obtaining the prediction by receiving the prediction.

36. The apparatus according to claim 32, wherein the instructions, when executed by the one or more processors, further cause the apparatus to perform, if the prediction is obtained by generating the prediction:
requesting the at least one of the estimation of the location of the terminal together with the estimation of the speed of the terminal and the movement direction of the terminal and the estimations of the locations of the terminal at different points in time if the source cell configures the terminal and the target cell for the conditional handover.

37. An apparatus comprising:
one or more processors, and memory storing instructions that, when executed by the one or more processors, cause the apparatus to perform:
supervising whether a target cell is configured, by a source cell, for a conditional handover of a first terminal from the source cell to the target cell, wherein the configuring of the target cell for the conditional handover of the first terminal comprises reserving a resource of the target cell for the first terminal;
monitoring whether an information on a handover delay period for the conditional handover is received from the source cell, wherein the handover delay period indicates a time period for which the first terminal will likely not perform the conditional handover to the target cell;
controlling the resource of the target cell in accordance with the handover delay period if the target cell is configured for the conditional handover of the first terminal and the information on the handover delay period is received.

38. The apparatus according to claim 37, wherein the instructions, when executed by the one or more processors, further cause the apparatus to perform:
checking whether the handover delay period is longer than a first predetermined threshold; wherein
the controlling comprises admitting to use the resource for a second terminal different from the first terminal during the handover delay period or a predefined portion of the handover delay period if the handover delay period is longer than the predetermined threshold.

39. The apparatus according to claim 38, wherein the controlling comprises reserving the resource for the first terminal after the handover delay period and the predefined portion of the handover delay period, respectively, has elapsed.

40. The apparatus according to claim 37, wherein the instructions, when executed by the one or more processors, further cause the apparatus to perform:
checking whether the handover delay period is longer than a second predetermined threshold;
informing the source cell that the target cell is not prepared for the conditional handover of the first terminal if the handover delay period is longer than the second predetermined threshold; wherein
the controlling comprises deleting the reservation of the resource for the first terminal if the handover delay period is longer than the second predetermined threshold.

41. The apparatus according to claim 37, wherein the monitoring whether the information on the handover delay period for the conditional handover is received from the source cell comprises monitoring whether a cancellation of the configuration for the conditional handover of the terminal is received along with the information on the handover delay period, and the instructions, when executed by the one or more processors, further cause the apparatus to perform:
maintaining a context of the terminal for a period of time longer than the handover delay period.

42. An apparatus comprising:
one or more processors, and memory storing instructions that, when executed by the one or more processors, cause the apparatus to perform:
monitoring whether a source cell configures a terminal and a target cell for a conditional handover of the terminal from the source cell to the target cell;
estimating a handover delay period if the source cell configures the terminal and the target cell for the conditional handover, wherein the handover delay period indicates a time period for which, according to a prediction of a likely future movement of the terminal, the terminal will likely not perform the conditional handover to the target cell;
supervising whether the source cell obtains an indication of an actual delay of the conditional handover;
adapting the prediction based on the actual delay and the handover delay period if the source cell obtains the indication of the actual delay.

43. The apparatus according to claim 42, wherein the supervising comprises supervising whether the source cell receives an indication of an actual delay of the conditional handover from the target cell.

44. The apparatus according to claim 42, wherein the instructions, when executed by the one or more processors, further cause the apparatus to perform:
determining an actual delay of the conditional handover based on a signaling message received for an execution of the conditional handover.

45. The apparatus according to claim 42, wherein the instructions, when executed by the one or more processors, further cause the apparatus to perform:
obtaining the prediction of the likely future movement of the terminal.

46. The apparatus according to claim 42, wherein the instructions, when executed by the one or more processors, further cause the apparatus to perform:
obtaining the prediction of the likely future movement of the terminal.
